(19) United States
(12) Patent Application Publication
(10) Pub. No.: US 2024/0307997 A1
(43) Pub. Date: Sep. 19, 2024

(54) LASER PROCESSING DEVICE AND LASER PROCESSING METHOD

(71) Applicant: HAMAMATSU PHOTONICS K.K., Hamamstu-shi, Shizuoka (JP)

(72) Inventors: Akira TAKEDA, Hamamatsu-shi, Shizuoka (JP); Hirotake FUKUOKA, Hamamatsu-shi, Shizuoka (JP)

(73) Assignee: HAMAMATSU PHOTONICS K.K., Hamamatsu-shi, Shizuoka (JP)

(21) Appl. No.: 18/576,191

(22) PCT Filed: Mar. 17, 2022
(86) PCT No.: PCT/JP2022/012328

§ 371 Date: Jan. 3, 2024

(30) Foreign Application Priority Data
Jul. 5, 2021 (JP) 2021-111363

(51) Int. Cl. B23K 26/03; B23K 26/046; B23K 26/06; B23K 26/082; B23K 26/70

(52) U.S. Cl. CPC B23K 26/032; B23K 26/046; B23K 26/0648; B23K 26/082; B23K 26/705

(57) ABSTRACT

A laser processing apparatus according to an embodiment includes a laser beam source, a stage, an fθ lens, a galvano scanner that scans a processed surface of a processing target with a laser beam by operating a dielectric mirror to adjust an incident angle of the laser beam with respect to the fθ lens, a polarization beam splitter disposed between the laser beam source and the galvano scanner on an optical path of the laser beam, a quarter-wave plate disposed between the polarization beam splitter and the galvano scanner on the optical path, and a light detection unit that detects a return beam of the laser beam from the processed surface irradiated with the laser beam, the return beam passing through the fθ lens, the galvano scanner, the quarter-wave plate, and the polarization beam splitter in this order.

### TECHNICAL FIELD

The present disclosure relates to a laser processing apparatus and a laser processing method.

### BACKGROUND ART

Patent Literature 1 discloses a configuration in which, in a laser processing apparatus that scans a surface of a processing target with a laser beam using a galvano scanner, a quarter-wave plate is disposed between an fθ lens and the processing target in order to suitably detect reflected light from the processing target by a light detection unit.

### CITATION LIST

### Patent Literature

Patent Literature 1: Japanese Unexamined Patent Publication No. 2007-29964

### SUMMARY OF INVENTION

### Technical Problem

In the configuration disclosed in Patent Literature 1, since the quarter-wave plate is located at the subsequent stage of a laser beam scanning unit (that is, closer to the processing target than the laser beam scanning unit), it is necessary to use a quarter-wave plate having a size that covers the entire processed surface (that is, scanning target region) of the processing target. Accordingly, it is necessary to increase the size of the quarter-wave plate according to the size of the processed surface. As a result, the size of the entire apparatus may be increased. In addition, at the time of laser processing, the quarter-wave plate may be contaminated by splashes or the like generated from the processing target.

In view of the above, an object of one aspect of the present disclosure is to provide a laser processing apparatus and a laser processing method capable of reducing the size of the apparatus and suppressing contamination of a quarter-wave plate.

### Solution to Problem

A laser processing apparatus according to one aspect of the present disclosure includes a laser beam source configured to output a laser beam, a support unit configured to support a processing target, an fθ lens configured to focus the laser beam on a processed surface of the processing target, an optical scanning unit configured to scan the processed surface with the laser beam by operating a dielectric mirror to adjust an incident angle of the laser beam with respect to the fθ lens, a polarization beam splitter disposed between the laser beam source and the optical scanning unit on an optical path of the laser beam, a quarter-wave plate disposed between the polarization beam splitter and the optical scanning unit on the optical path, and a light detection unit configured to detect a return beam of the laser beam from the processed surface of the processing target irradiated with the laser beam, the return beam passing through the fθ lens, the optical scanning unit, the quarter-wave plate, and the polarization beam splitter in this order.

In the laser processing apparatus, by using the polarization beam splitter and the quarter-wave plate, the detection efficiency of the return beam from the processed surface of the processing target can be improved as compared with a case where the polarization beam splitter and the quarter-wave plate are not used. Furthermore, by disposing the quarter-wave plate between the polarization beam splitter and the optical scanning unit, the size of the quarter-wave plate can be reduced as compared with a case where the quarter-wave plate is disposed between the fθ lens and the processing target. As a result, the entire laser processing apparatus can be downsized. In addition, by not disposing the quarter-wave plate at a position facing the processing target, it is also possible to suppress contamination of the quarter-wave plate due to splashes or the like generated from the processing target at the time of laser processing.

The laser processing apparatus may further include a control unit configured to monitor a processing state of the processing target on the basis of the return beam detected by the light detection unit. With the above configuration, the processing state of the processing target can be easily monitored on the basis of the return beam detected at the time of laser processing.

The light detection unit may detect the signal strength of the return beam, and the control unit may detect an abnormality of a processing state of the processing target on the basis of the signal strength detected by the light detection unit. With the above configuration, it is possible to appropriately detect the abnormality of the processing state on the basis of the signal strength of the return beam and appropriately handle the abnormality.

The control unit may correct the signal strength on the basis of a scanning position of the laser beam, and may detect an abnormality of a processing state of the processing target on the basis of the signal strength after correction. The laser beam output from the laser beam source is transmitted through the polarization beam splitter to become a linear polarization beam, and is further transmitted through the quarter-wave plate to be converted into a circular polarization beam. Here, in a case where the optical scanning unit including the dielectric mirror is used, when the laser beam is reflected by the dielectric mirror, a phase difference between orthogonal polarization beams of the laser beam changes. Due to this, the return beam near the center of the scanning range is maintained in the state of the circular polarization beam, whereas the return beam of a peripheral edge deviated from the center of the scanning range is an elliptical polarization beam. As a result, there is a difference between the signal strength detected for the return beam of the central portion of the scanning range and the signal strength detected for the return beam of the peripheral edge of the scanning range. Specifically, the signal strength of the detected return beam tends to decrease as the irradiation position (scanning position) of the laser beam is farther from the center of the scanning range. With the above configuration, the magnitudes of the signal strength of the return beam detected at each position in the scanning range can be equalized by correcting the signal strength on the basis of such a tendency. Thus, it is possible to determine whether or not laser processing is normally performed for each scanning position on the basis of a uniform reference.

The control unit may determine whether or not laser processing at a scanning position is normally performed on the basis of the signal strength detected at the scanning position every time the irradiation of the scanning position with the laser beam is executed, and detect an abnormality of a processing state of the processing target in response to a determination that the laser processing at the scanning position is not normally performed. With the above configuration, it is possible to appropriately and immediately detect the abnormality of the processing state during the processing step.

The control unit may determine whether or not the signal strength is an appropriate value on the basis of a relationship among irradiation energy of the laser beam output from the laser beam source, the signal strength, and a diameter of a processing mark formed on the processed surface, and a target value of the diameter of the processing mark, and may detect an abnormality of a processing state of the processing target in response to a determination that the signal strength is not an appropriate value. With the above configuration, during the processing step, the abnormality of the processing state can be appropriately detected on the basis of the relationship among the irradiation energy of the laser beam, the signal strength of the return beam, and the diameter of the processing mark.

The control unit may integrate the signal strength detected at each scanning position in an entire predetermined scanning range, and may detect an abnormality of a processing state of the processing target on the basis of an integration result. With the above configuration, by using the integration result of the signal strength detected in the entire scanning range, a difference in the signal strength due to a difference in the scanning position can be absorbed, and the abnormality can be detected in units of the scanning range. Further, the signal strength of the return beam detected at each scanning position does not need to be corrected, and thus the amount of calculation can be reduced accordingly.

The light detection unit may detect a two-dimensional image of the return beam, and the control unit may adjust a distance between the fθ lens and the processed surface on the basis of the two-dimensional image detected by the light detection unit. With the above configuration, the distance between the fθ lens and the processed surface can be adjusted so that the beam profile at the processing position (irradiation position) has an appropriate shape on the basis of the two-dimensional image of the return beam (that is, the beam profile) from the processing target. Thus, the processing quality can be improved.

The control unit may adjust a distance between the fθ lens and the processed surface in such a manner that the two-dimensional image corresponding to a target shape is detected by the light detection unit on the basis of a relationship between the two-dimensional image and a shape of a processing mark formed on the processed surface, and the target shape of the processing mark. With the above configuration, the distance between the fθ lens and the processed surface can be appropriately adjusted on the basis of the relationship between the two-dimensional image and the shape of the processing mark grasped in advance.

A laser processing method according to another aspect of the present disclosure is a laser processing method for processing a processing target by focusing a laser beam on a processed surface of the processing target supported by a support unit with an fθ lens, the laser processing method including a step of guiding the laser beam output from a laser beam source to an optical scanning unit through a polarization beam splitter and a quarter-wave plate in this order, and scanning, in the optical scanning unit, the processed surface with the laser beam by operating a dielectric mirror to change an incident angle of the laser beam with respect to the fθ lens, and a step of detecting, by a light detection unit, a return beam of the laser beam from the processed surface of the processing target irradiated with the laser beam, the return beam passing through the fθ lens, the optical scanning unit, the quarter-wave plate, and the polarization beam splitter in this order. According to the above laser processing method, effects similar to those of the laser processing apparatus described above are obtained.

The laser processing method may further include a step of monitoring a processing state of the processing target on the basis of the return beam detected by the light detection unit. With the above configuration, the processing state of the processing target can be easily monitored on the basis of the return beam detected at the time of laser processing.

In the step of detecting, signal strength of the return beam may be detected, and in the step of monitoring, an abnormality of a processing state of the processing target may be detected on the basis of the detected signal strength. With the above configuration, it is possible to appropriately detect the abnormality of the processing state on the basis of the signal strength of the return beam and appropriately handle the abnormality.

The step of monitoring may include a step of correcting the signal strength on the basis of a scanning position of the laser beam, and a step of detecting an abnormality of a processing state of the processing target on the basis of the signal strength after correction. With the above configuration, the magnitudes of the signal strength of the return beam detected at respective positions in the scanning range are equalized, and whether or not the laser processing is normally performed can be determined for each scanning position on the basis of a uniform reference.

The step of monitoring may include a step of determining whether or not laser processing at a scanning position is normally performed on the basis of the signal strength detected at the scanning position every time the irradiation of the scanning position with the laser beam is executed, and a step of detecting an abnormality of a processing state of the processing target in response to a determination that the laser processing at the scanning position is not normally performed. With the above configuration, it is possible to appropriately and immediately detect the abnormality of the processing state during the processing step.

The step of monitoring may include a step of determining whether or not the signal strength is an appropriate value on the basis of a relationship among irradiation energy of the laser beam output from the laser beam source, the signal strength, and a diameter of a processing mark formed on the processed surface, and a target value of the diameter of the processing mark, and a step of detecting an abnormality of a processing state of the processing target in response to a determination that the signal strength is not an appropriate value. With the above configuration, during the processing step, the abnormality of the processing state can be appropriately detected on the basis of the relationship among the irradiation energy of the laser beam, the signal strength of the return beam, and the diameter of the processing mark.

The step of monitoring may include a step of integrating the signal strength detected at each scanning position in an entire predetermined scanning range, and a step of detecting an abnormality of a processing state of the processing target on the basis of an integration result. With the above configuration, by using the integration result of the signal strength detected in the entire scanning range, a difference in the signal strength due to a difference in the scanning position can be absorbed, and the abnormality can be detected in units of the scanning range. Further, the signal strength of the return beam detected at each scanning position does not need to be corrected, and thus the amount of calculation can be reduced accordingly.

In the step of detecting, a two-dimensional image of the return beam may be detected, and in the step of monitoring, a distance between the fθ lens and the processed surface may be adjusted on the basis of the detected two-dimensional image. With the above configuration, the distance between the fθ lens and the processed surface can be adjusted so that the beam profile at the processing position (irradiation position) has an appropriate shape on the basis of the two-dimensional image of the return beam (that is, the beam profile) from the processing target. Thus, the processing quality can be improved.

In the step of monitoring, a distance between the fθ lens and the processed surface may be adjusted in such a manner that the two-dimensional image corresponding to a target shape is detected by the light detection unit on the basis of a relationship between the two-dimensional image and a shape of a processing mark formed on the processed surface, and a target shape of the processing mark. With the above configuration, the distance between the fθ lens and the processed surface can be appropriately adjusted on the basis of the relationship between the two-dimensional image and the shape of the processing mark grasped in advance.

### Advantageous Effects of Invention

According to one aspect of the present disclosure, it is possible to provide a laser processing apparatus and a laser processing method capable of reducing the size of the apparatus and suppressing contamination of a quarter-wave plate.

### BRIEF DESCRIPTION OF DRAWINGS

FIG. 1 is a configuration diagram of a laser processing apparatus of a first embodiment.

FIG. 2 is a diagram illustrating an example of a processing target, signal strength of a return beam detected by a light detection unit, and a processing mark formed on a processed surface.

FIG. 3 is a diagram illustrating an example of correction processing of the signal strength of the return beam.

FIG. 4 is a diagram illustrating an example of a relationship among irradiation energy of a laser beam, signal strength of a return beam, and a diameter of a processing mark.

FIG. 5 is a diagram illustrating a first operation example of the laser processing apparatus of the first embodiment.

FIG. 6 is a diagram illustrating a second operation example of the laser processing apparatus of the first embodiment.

FIG. 7 is a configuration diagram of a laser processing apparatus of a second embodiment.

FIG. 8 is a diagram illustrating an example of a relationship between a two-dimensional image of a return beam detected by the laser processing apparatus of the second embodiment and a processing mark.

FIG. 9 is a diagram illustrating an example of operation of the laser processing apparatus of the second embodiment.

FIG. 10 is a diagram illustrating an example of a relationship between irradiation energy and a processing mark diameter measured by the laser processing apparatus of the second embodiment.

### DESCRIPTION OF EMBODIMENTS

Hereinafter, an embodiment of the present invention will be described in detail with reference to the drawings. Note that, in the following description, the same or equivalent elements are denoted by the same reference numerals, and redundant description thereof will be omitted.

### First Embodiment

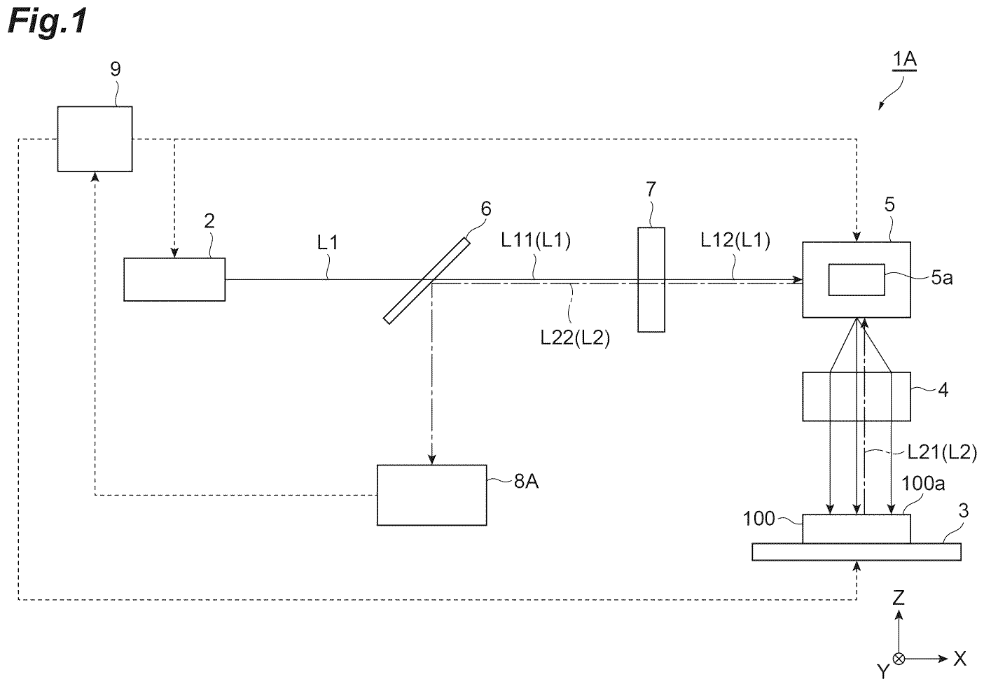

A laser processing apparatus 1A of a first embodiment illustrated in FIG. 1 is an apparatus that processes a processing target 100 by irradiating a processed surface 100a of the processing target 100 with a laser beam L1. The laser processing apparatus 1A includes a laser beam source 2, a stage 3 (supporting unit), an fθ lens 4, a galvano scanner 5 (optical scanning unit), a polarization beam splitter 6, a quarter-wave plate 7, a light detection unit 8A, and a control unit 9.

The laser beam source 2 is a device that outputs the laser beam L1 with which the processing target 100 is irradiated. The laser beam L1 output from the laser beam source 2 may be continuous light or pulsed light. In the present embodiment, the laser beam L1 is pulsed light. Further, the wavelength of the laser beam L1 output from the laser beam source 2 is appropriately selected according to the materials (for example, metal, resin, and the like) of the processing target 100. The wavelength of the laser beam L1 is, for example, 1030 nm.

The stage 3 is a device that supports the processing target 100. For example, the processing target 100 is placed on a placement surface (upper surface) of the stage 3. The stage 3 is, for example, an XYZ stage that is movable in an X-axis direction and a Y-axis direction parallel to the placement surface of the stage 3 and orthogonal to each other, and a Z-axis direction orthogonal to the placement surface of the stage 3.

The fθ lens 4 is a lens that focuses the laser beam L1 on the processed surface 100a of the processing target 100 placed on the stage 3. The fθ lens 4 includes a plurality of lenses. By using the fθ lens 4 as an objective lens for the processing target 100, a constant velocity scan can be executed on the processed surface 100a.

The galvano scanner 5 includes a galvano mirror 5a (dielectric mirror). The galvano scanner 5 scans the processed surface 100a with the laser beam L1 by operating the galvano mirror 5a to adjust the incident angle of the laser beam L1 with respect to the fθ lens 4. The galvano scanner 5 may be configured to scan the processed surface 100a one-dimensionally or may be configured to scan the processed surface 100a two-dimensionally. In the latter case, the galvano scanner 5 includes, for example, a first galvano mirror for scanning the processed surface 100a with the laser beam L1 in the X-axis direction, and a second galvano mirror for scanning the processed surface 100a with the laser beam L1 in the Y-axis direction.

The polarization beam splitter 6 is disposed between the laser beam source 2 and the galvano scanner 5 on the optical path of the laser beam L1. Specifically, the polarization beam splitter 6 is disposed between the laser beam source 2 and the quarter-wave plate 7. The polarization beam splitter 6 is arranged to be inclined by 45 degrees with respect to the optical path of the laser beam L1 so that the incident angle of the laser beam L1 with respect to the polarization beam splitter 6 is 45 degrees. The polarization beam splitter 6 has a property of transmitting a first polarization component (for example, a p-polarization component) of the laser beam L1 and reflecting a second polarization component (for example, an s-polarization component) orthogonal to the first polarization component of the laser beam L1. Therefore, the laser beam L1 having passed through the polarization beam splitter 6 becomes a linear polarization beam L11 containing only the first polarization component.

The quarter-wave plate 7 is disposed between the polarization beam splitter 6 and the galvano scanner 5 on the optical path of the laser beam L1. The quarter-wave plate 7 mutually converts a linear polarization beam and a circular polarization beam. That is, the linear polarization beam transmitted through the quarter-wave plate 7 is converted into a circular polarization beam, and the circular polarization beam transmitted through the quarter-wave plate 7 is converted into linear polarization beam. Therefore, the laser beam L1 (linear polarization beam L11) having passed through the polarization beam splitter 6 becomes a circular polarization beam L12 when transmitted through the quarter-wave plate 7.

The light detection unit 8A detects a return beam L2 of the laser beam L1 from the processed surface 100a of the processing target 100 irradiated with the laser beam L1. In the present embodiment, the light detection unit 8A detects the signal strength of the return beam L2. The light detection unit 8A is, for example, a photodiode. After being reflected by the processed surface 100a, the return beam L2 reaches the light detection unit 8A via the fθ lens 4, the galvano scanner 5, the quarter-wave plate 7, and the polarization beam splitter 6 in this order.

In the laser processing apparatus 1A having the above configuration, the laser beam L1 output from the laser beam source 2 passes through the polarization beam splitter 6, the quarter-wave plate 7, the galvano scanner 5, and the fθ lens 4 in this order, and is emitted to the processed surface 100a of the processing target 100 placed on the stage 3. The laser beam L1 passes through the polarization beam splitter 6 to become the linear polarization beam L11 containing only the first polarization component. Thereafter, the laser beam L1 (linear polarization beam L11) passes through the quarter-wave plate 7 to become the circular polarization beam L12 corresponding to the first polarization component. The laser beam L1 is emitted to the processed surface 100a of the processing target 100 on the stage 3 via the galvano scanner 5 and the fθ lens 4 in a state of the circular polarization beam L12.

Apart of the laser beam L1 is reflected on the processed surface 100a to generate the return beam L2. The return beam L2 immediately after being reflected by the processed surface 100a is a circular polarization beam L21 having a rotation direction opposite to that of the laser beam L1 (circular polarization beam L12) incident on the processed surface 100a. The return beam L2 (circular polarization beam L21) passes through the quarter-wave plate 7 via the fθ lens 4 and the galvano scanner 5. At this time, the return beam L2 (circular polarization beam L21) is converted into a linear polarization beam L22 by the quarter-wave plate 7. Here, the rotation direction of the return beam L2 (circular polarization beam L21) incident on the quarter-wave plate 7 is opposite to the rotation direction of the laser beam L1 (circular polarization beam L12) after passing through the quarter-wave plate 7. Therefore, the return beam L2 (linear polarization beam L22) having passed through the quarter-wave plate 7 is a linear polarization beam including only the second polarization component having a polarization direction different by 90 degrees from that of the laser beam L1 (linear polarization beam L11) before passing through the quarter-wave plate 7. Therefore, the return beam L2 (linear polarization beam L22) is not transmitted through the polarization beam splitter 6 and is reflected by the polarization beam splitter 6. The light detection unit 8A is arranged on the optical path of the return beam L2 (linear polarization beam L22) thus reflected. As described above, by using the polarization beam splitter 6 and the quarter-wave plate 7, it is possible to detect the return beam L2 in the light detection unit 8A while performing laser processing with the laser beam L1 on the processing target 100.

The control unit 9 monitors the processing state of the processing target 100 on the basis of the return beam L2 detected by the light detection unit 8A. The processing state is, for example, a state (for example, shape, diameter, depth, and the like) of a processing mark formed at the irradiation position (scanning position) of the laser beam L1. Further, in the present embodiment, the control unit 9 detects an abnormality of the processing state of the processing target 100 on the basis of the signal strength of the return beam L2 detected by the light detection unit 8A.

The control unit 9 can be configured by, for example, a computer device including a processor such as a central processing unit (CPU), a memory such as a random access memory (RAM) or a read only memory (ROM), an auxiliary storage device such as a hard disk drive (HDD) or a solid state drive (SSD), and the like. The control unit 9 is communicably connected to each unit (in the present embodiment, the laser beam source 2, the stage 3, the galvano scanner 5, and the light detection unit 8A) of the laser processing apparatus 1A, and controls the operation of each unit.

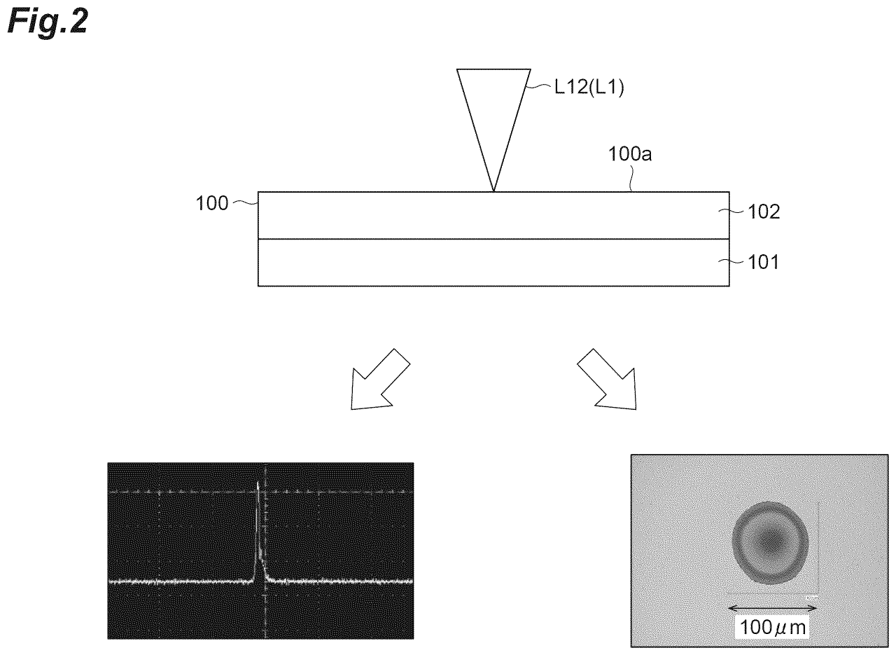

FIG. 2 is a diagram illustrating an example of the processing target 100, signal strength of the return beam L2 detected by the light detection unit 8A, and a processing mark formed on the processed surface 100a. As illustrated in the upper part of FIG. 2, in the present embodiment, as an example, the processing target 100 includes a silicon substrate (silicon wafer) 101 and a metal layer 102 formed on the silicon substrate 101. As an example, the metal layer 102 is formed by gold (Au) having a thickness of 100 nm. In this example, the processed surface 100a is a surface of the metal layer 102 on a side opposite to the silicon substrate 101 side.

The lower left part of FIG. 2 illustrates an example of a signal waveform of the return beam L2 (detection light) detected by the light detection unit 8A when a certain scanning position on the processed surface 100a of the processing target 100 is irradiated with the pulsed laser beam L1 for one shot. As illustrated in FIG. 2, in a case where the laser beam L1 is pulsed light, the signal waveform of the obtained return beam L2 also has a pulse shape. For example, the light detection unit 8A acquires a detection peak value (mV) of the pulsed return beam L2 as the signal strength of the return beam L2.

A lower right part of FIG. 2 illustrates an example of an observation image of a processing mark formed at a scanning position of the processed surface 100a after the certain scanning position on the processed surface 100a of the processing target 100 is irradiated with the pulsed laser beam L1 for one shot. Such an observation image is obtained by observation using a microscope or the like.

As described above, the laser beam L1 output from the laser beam source 2 is transmitted through the polarization beam splitter 6 to become the linear polarization beam L11, and is further transmitted through the quarter-wave plate 7 to be converted into the circular polarization beam L12. Here, in a case where the galvano scanner 5 including the galvano mirror 5a (dielectric mirror) is used as the optical scanning unit as in the present embodiment, when the laser beam L1 is reflected by the galvano mirror 5a, the phase difference between the orthogonal polarizations of the laser beam L1 changes. Due to this, the return beam L2 near the center of the scanning range (that is, a range scannable by the galvano scanner 5) of the processed surface 100a is maintained in a state close to a circular polarization beam (perfect circle), whereas the return beam L2 at a peripheral edge deviated from the center of the scanning range is an elliptical polarization beam. More specifically, when the galvano scanner 5 is adjusted so that the return beam L2 obtained when the central portion of the range (for example, a line segment region in a case of one-dimensional scanning, and a rectangular region in a case of two-dimensional scanning) scannable by the galvano scanner 5 on the processed surface 100a is irradiated with the laser beam L1 becomes a circular polarization beam, the polarization state of the return beam L2 becomes an elliptical shape having a higher flatness as the scanning position of the laser beam L1 is farther from the central portion. As a result, there is a difference between the signal strength of the return beam L2 from the central portion of the scanning range and the signal strength of the return beam L2 from the peripheral edge of the scanning range. Specifically, the signal strength of the return beam L2 detected by the light detection unit 8A tends to decrease as the scanning position of the laser beam L1 is farther from the central portion of the scanning range. Note that such a relationship (optical characteristic) between the scanning range and the signal strength is uniquely determined by the used galvano scanner 5. That is, the relationship between the scanning range and the signal strength does not change with time or due to a difference in the processing target 100.

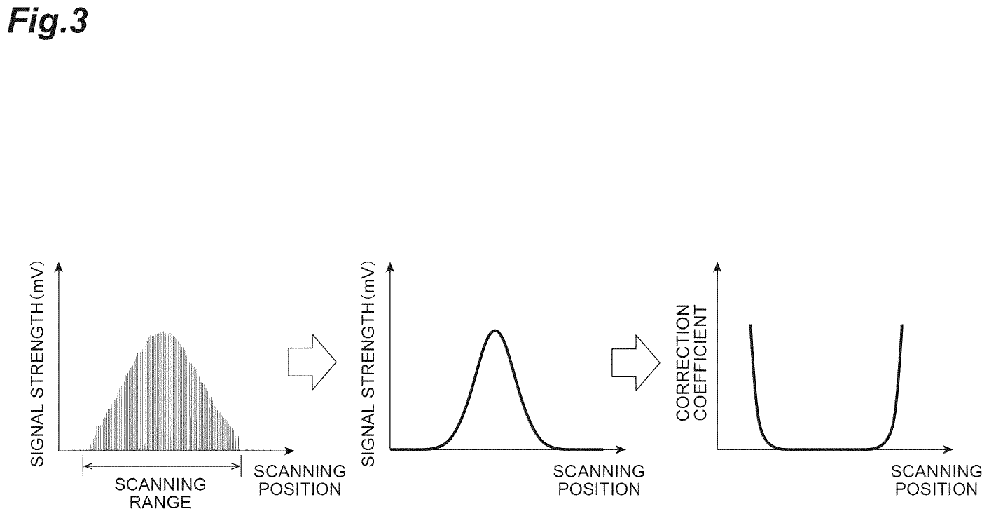

Thus, the control unit 9 may correct the signal strength of the return beam L2 obtained by the light detection unit 8A on the basis of the scanning position of the laser beam L1. An example of correction processing by the control unit 9 will be described with reference to FIG. 3. Here, a case of performing one-dimensional scanning with the laser beam L1 (that is, a case where the scanning range is a one-dimensional line segment region) will be described as an example.

The left part of FIG. 3 illustrates an example of signal strength data indicating the signal strength (mV) of the return beam L2 at each scanning position acquired by the light detection unit 8A. As illustrated in the left part of FIG. 3, the signal strength (detection peak value) of the return beam L2 detected by the light detection unit 8A becomes maximum at the central portion of the scanning range, and decreases as the distance from the central portion of the scanning range increases. That is, as illustrated in the left part of FIG. 3, when the horizontal axis represents the scanning position and the vertical axis represents the signal strength, the contour of a graph representing the signal strength of the return beam L2 for each scanning position has a mountain shape. The control unit 9 derives a fitting function by performing curve fitting on such signal strength data.

The central portion of FIG. 3 illustrates an example of a fitting function obtained from the signal strength data of the left part of FIG. 3. Subsequently, the control unit 9 calculates a correction coefficient (offset amount) for setting the signal strength of the return beam L2 at each scanning position to a value equivalent to the signal strength of the return beam L2 at the central portion of the scanning range on the basis of the fitting function. For example, in a case where the signal strength of the return beam L2 at the central portion of the scanning range is represented as Imax, the signal strength of the return beam L2 at any scanning position p other than the central portion is represented as Ip, and the correction coefficient at the scanning position p is represented as r, the control unit 9 calculates a correction coefficient r so that “Imax≈Ip+r” for each scanning position p.

The right part of FIG. 3 illustrates an example of the correction coefficient of each scanning position obtained in this manner. By adding the correction coefficient corresponding to the scanning position to the signal strength of the return beam L2 detected by the light detection unit 8A, the control unit 9 can obtain the signal strength equivalent to the signal strength obtained in the central portion of the scanning range for each scanning position. As a result, it is possible to perform processing (for example, detection of abnormality of a processing state, adjustment of irradiation energy of the laser beam L1, and the like) based on the signal strength of the return beam L2 on a uniform reference regardless of the scanning position. Note that, even in a case of performing two-dimensional scanning with the laser beam L1, the control unit 9 can calculate the correction coefficient for each scanning position on the basis of a concept similar to that in a case of performing one-dimensional scanning with the laser beam L1. Further, the correction coefficient is not limited to the above example. For example, a correction coefficient r that satisfies “Imax≈Ip×r” may be used.

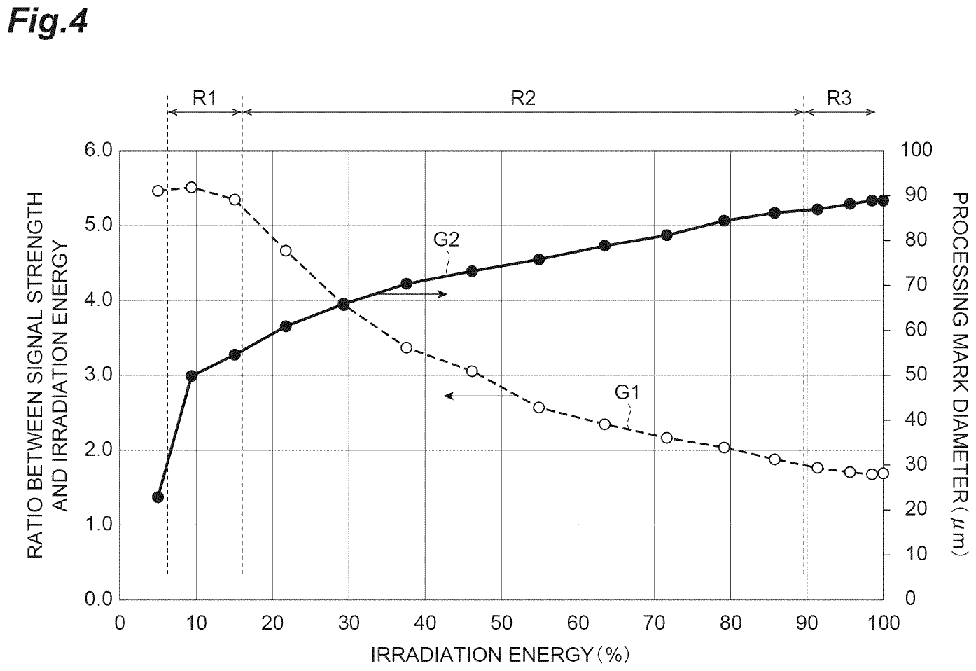

FIG. 4 is a diagram illustrating an example of a relationship among the irradiation energy of the laser beam L1, the signal strength of the return beam L2, and a diameter of a processing mark. In FIG. 4, the horizontal axis represents the irradiation energy (%) when the maximum value (maximum output of the laser beam source 2) of the irradiation energy (μJ) of the laser beam L1 is 100%. The vertical axis represents the ratio (that is, “a detection peak value (mV) of the return beam L2 detected by the light detection unit 8A/irradiation energy (μJ) of the laser beam L1”) between the signal strength (mV) of the return beam L2 and the irradiation energy (μJ) of the laser beam L1 and the diameter (μm) of the processing mark (see the lower right part of FIG. 2) formed on the processed surface 100a. A graph G1 illustrated in FIG. 4 illustrates a relationship between the irradiation energy of the laser beam L1 and the signal strength of the return beam L. A graph G2 illustrates the relationship between the irradiation energy of the laser beam L1 and the diameter of the processing mark formed on the processed surface 100a.

For example, the graph G1 is obtained as follows. As described above, with the laser processing apparatus 1A, the light detection unit 8A can detect the signal strength of the return beam L2 while performing laser processing (irradiation with the laser beam L1) on the processing target 100. The control unit 9 can obtain the graph G1 by performing arithmetic processing based on the irradiation energy of the laser beam L1 and the signal strength of the return beam L2 detected by the light detection unit 8A. Here, as described above, the control unit 9 can correct the signal strength of the return beam L2 on the basis of the scanning position of the laser beam L1. More specifically, the control unit 9 adds the correction coefficient corresponding to the scanning position to the signal strength of the return beam L2 detected by the light detection unit 8A, thereby obtaining the signal strength based on the signal strength obtained in the central portion of the scanning range at an arbitrary scanning position. Therefore, for example, the graph G1 can be easily generated by detecting the signal strength of the return beam L2 while changing the irradiation energy of the laser beam L1 for each scanning position on the processed surface 100a of the same processing target 100, correcting the detected signal strength according to the scanning position, and using the signal strength after correction.

For example, the graph G2 is obtained as follows. That is, the diameter of the processing mark is acquired by acquiring an observation image of the processing mark formed at each scanning position after the laser processing is performed on the processing target 100 and analyzing the acquired observation image. Then, the graph G2 can be obtained by associating the acquired diameter with the irradiation energy of the laser beam L1 emitted to each scanning position.

As illustrated in FIG. 4, in this example, three classifications (regions R1, R2, and R3) of the processing state according to the irradiation energy of the laser beam L1 are grasped from the graphs G1 and G2 and an observation image acquired when the graph G2 is created.

The region R1 where the irradiation energy of the laser beam L1 is 5% to 15% of the maximum output is a region where a small part of the irradiation energy of the laser beam L1 emitted to the processing target 100 is converted into processing energy for processing the processed surface 100a. In the region R1, the return beam L2 is detected with a relatively high reflectance (that is, the ratio of the signal strength of the return beam L2 to the irradiation energy of the laser beam L1). In addition, in the region R1, a part of the metal layer 102 on the silicon substrate 101 is processed, and the change rate of the diameter of the processing mark with respect to the irradiation energy of the laser beam L1 becomes relatively large.

The region R2 where the irradiation energy of the laser beam L1 is 15% to 90% of the maximum output is a region where a part of the irradiation energy (at a higher ratio than in the region R1) of the laser beam L1 emitted to the processing target 100 is converted into the processing energy. In the region R2, the reflectance of the return beam L2 is lower than that in the region R1. Further, in the region R2, a part of the metal layer 102 on the silicon substrate 101 is removed, and the size of the region to be removed (the diameter of the processing mark) changes according to the irradiation energy of the laser beam L1. In the region R2, as the irradiation energy increases, the reflectance to the irradiation energy decreases in a substantially linear manner, and the diameter of the processing mark increases in a substantially linear manner.

The region R3 where the irradiation energy of the laser beam L1 is 90% to 100% of the maximum output is a region where the diameter of the processing mark is about the maximum diameter determined by the optical system of the laser processing apparatus 1A, and both the reflectance and the diameter of the processing mark are saturated.

In the example illustrated in FIG. 4, it has been confirmed that there is a correlation between the ratio of the return beam L2 to the irradiation energy of the laser beam L1 (reflectance of the return beam L2) and the diameter of the processing mark. By using such a correlation, while executing laser processing (irradiation with the laser beam L1) on the processing target 100, the control unit 9 can determine whether or not the diameter of the processing mark to be formed on the processed surface 100a coincides with a predetermined target value (or target range) on the basis of the signal strength of the return beam L2 detected by the light detection unit 8A (in the present embodiment, a correction value obtained by adding a correction coefficient corresponding to the scanning position, and the same applies hereinafter).

For example, in the example of FIG. 4, it is assumed that the target value of the diameter of the processing mark is set to 75 μm. In this case, the control unit 9 can specify the irradiation energy of the laser beam L1 for setting the diameter of the processing mark to 75 μm from the graph G2 in FIG. 4. In the example of FIG. 4, “50%” is specified as the irradiation energy. Thus, the control unit 9 can control the output of the laser beam source 2 so that the irradiation energy of the laser beam L1 becomes 50%.

Furthermore, the control unit 9 can specify a ratio (that is, a normal value obtained when laser processing is normally performed) of the signal strength of the return beam L2 to the irradiation energy of the laser beam L1 when the irradiation energy of the laser beam L1 is set to 50% from the graph G1 of FIG. 4. In the example of FIG. 4, “2.8” is specified as the ratio. Therefore, the control unit 9 can monitor the signal strength of the return beam L2 obtained by the irradiation of the processed surface 100a with the laser beam L1, and determine whether or not the signal strength of the return beam L2 during the laser processing is an appropriate value on the basis of whether or not the ratio of the signal strength of the return beam L2 to the irradiation energy of the laser beam L1 matches 2.8 (alternatively, whether the difference from “2.8” is equal to or less than a predetermined threshold value). That is, the control unit 9 can determine whether or not the laser processing is normally performed on the processing target 100 on the basis of whether or not the ratio of the signal strength of the return beam L2 to the irradiation energy of the laser beam L1 is a predetermined normal value (in this example, a value within a predetermined threshold value from “2.8”). That is, when the signal strength of the return beam L2 is not an appropriate value (that is, when the ratio is not a predetermined normal value), the control unit 9 can detect an abnormality of the processing state (for example, the size of the diameter of the processing mark, and the like) of the processing target 100.

### First Operation Example

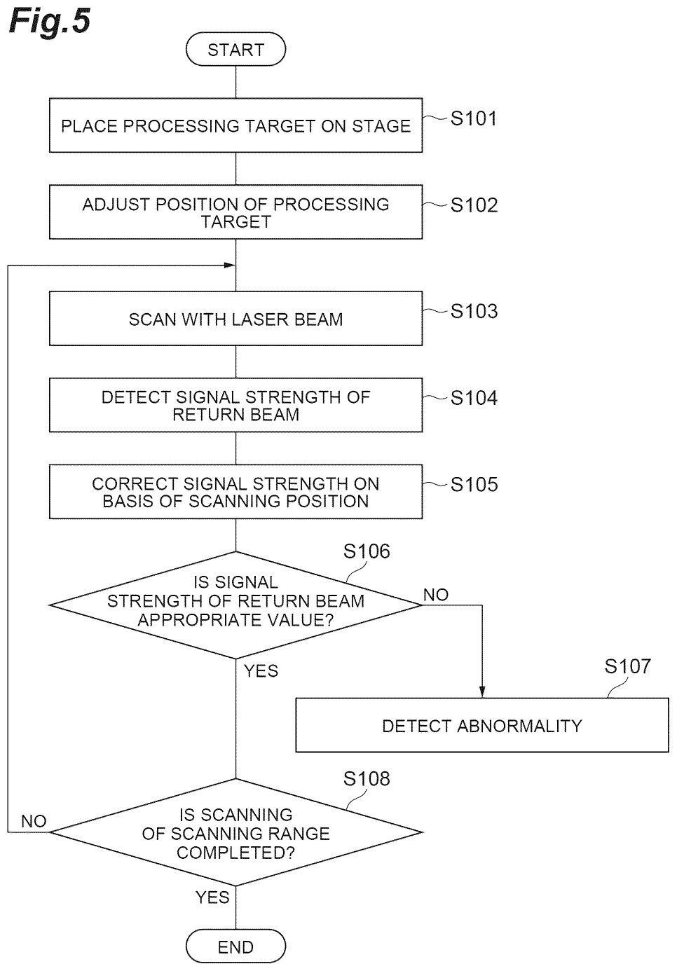

A first operation example of the laser processing apparatus 1A will be described with reference to FIG. 5. In step S101, the processing target 100 is placed on the stage 3. In step S102, the control unit 9 drives the stage 3 to perform position adjustment (alignment) of the processing target 100. In step S103, laser processing (scanning) is started. More specifically, the laser beam L1 output from the laser beam source 2 is guided to the galvano scanner 5 through the polarization beam splitter 6 and the quarter-wave plate 7 in this order, and scanning, in the galvano scanner 5, the processed surface 100a with the laser beam L1 by operating the galvano mirror 5a to change the incident angle of the laser beam L1 with respect to the fθ lens 4.

In step S104, the light detection unit 8A detects the return beam L2 of the laser beam L1. More specifically, the light detection unit 8A detects the return beam L2 of the laser beam L1 from the processed surface 100a of the processing target 100 irradiated with the laser beam L1, the return beam L2 having passed through the fθ lens 4, the galvano scanner 5, the quarter-wave plate 7, and the polarization beam splitter 6 in this order. In the present embodiment, the light detection unit 8A detects the signal strength (detection peak value) of the return beam L2 for each scanning position.

In step S105, the control unit 9 corrects the signal strength detected by the light detection unit 8A on the basis of the scanning position of the laser beam L1. As an example, the control unit 9 adds the correction coefficient for each scanning position calculated by the above-described method to the signal strength detected by the light detection unit 8A, thereby obtaining the signal strength after correction.

In step S106, the control unit 9 detects an abnormality of the processing state of the processing target 100 on the basis of the signal strength after correction. For example, the control unit 9 determines whether or not the signal strength of the return beam L2 acquired during the laser processing is an appropriate value (in the example of FIG. 4, such a value that the ratio of the signal strength of the return beam L2 to the irradiation energy of the laser beam L1 falls within a predetermined threshold value from “2.8”) on the basis of the graphs G1 and G2 (that is, information indicating the relationship between the irradiation energy of the laser beam L1 output from the laser beam source 2, the signal strength of the return beam L2, and the diameter of the processing mark formed on the processed surface 100a) of FIG. 4 and the target value (for example, 75 μm) of the diameter of the processing mark.

When it is determined that the signal strength of the return beam L2 is not an appropriate value (step S106: NO), the control unit 9 detects an abnormality of the processing state of the processing target 100 (step S107). Then, the control unit 9 executes predetermined abnormal-time processing. For example, the control unit 9 may control the operations of the laser beam source 2 and the galvano scanner 5 so as to perform additional processing (re-irradiation with the laser beam L1) on the scanning position where the abnormality is detected. In addition, the control unit 9 may adjust irradiation energy (output power) of the laser beam L1 by controlling the operation of the laser beam source 2. Further, the control unit 9 may stop the operation of the laser beam source 2 and the galvano scanner 5 and interrupt the laser processing at the time when the abnormality is detected. Furthermore, the control unit 9 may output display information indicating the occurrence of an error to a display unit such as a display included in the control unit 9, or may output an alert sound or the like indicating the occurrence of an error from a speaker or the like included in the control unit 9.

The processing of steps S103 to S106 is executed for each scanning position. That is, the processing of steps S103 to S106 is executed for each scanning position until the scanning of all the scanning positions within the predetermined scanning range is completed (step S108: NO). When it is determined that the signal strength of the return beam L2 is an appropriate value at each scanning position (step S106: YES) and the scanning of all the scanning positions is completed (step S108: YES), the laser processing on the processing target 100 by the laser processing apparatus 1A is normally completed.

In the first operation example described above, every time the irradiation of the scanning position with the laser beam L1 is executed, the control unit 9 determines whether or not the laser processing of the scanning position is normally performed (that is, whether or not the signal strength is an appropriate value) on the basis of the signal strength (in the present embodiment, the signal strength after correction of the return beam L2) detected at the scanning position. Then, the control unit 9 detects an abnormality of the processing state of the processing target 100 in response to the determination that the laser processing at the scanning position is not normally performed (step S106: NO).

### Second Operation Example

In the second operation example, after the laser processing (scanning) of the entire predetermined scanning range is completed, the control unit 9 integrates the signal strength of the return beam L2 detected by the light detection unit 8A for each scanning position of the entire scanning range, and detects the abnormality of the processing state of the processing target 100 on the basis of the integration result. This is based on the following idea. That is, as described above, there is a difference in the signal strength of the return beam L2 obtained at the central portion and the peripheral edge of the scanning range. Such a difference in the magnitude of the signal strength depending on the scanning position becomes a problem when the processing state is monitored for each scanning position. Therefore, in the first operation example of monitoring the processing state for each scanning position, the control unit 9 performs correction processing of the signal strength using the correction coefficient corresponding to the scanning position so that the signal strength of the return beam L2 obtained for each scanning position does not vary. On the other hand, when it is sufficient to monitor whether or not laser processing is normally performed in units of scanning ranges (for example, for each processing target 100), such correction processing can be omitted. For example, first, laser processing is performed on the entire scanning range of a certain processing target 100, and an integrated value of the signal strength of the return beam L2 detected at each scanning position of the entire scanning range is acquired. Then, whether the laser processing of the processing target 100 has been normally performed is confirmed afterwards by a predetermined inspection such as visual inspection. Thus, it is possible to grasp the integrated value (that is, the normal value of the integrated value) obtained when laser processing is normally performed on the entire scanning range (in this example, one processing target 100). Therefore, in a case where similar laser processing is performed on a plurality of the processing targets 100 of the same type, or the like, every time the laser processing of the entire scanning range of one processing target 100 is completed, the control unit 9 calculates an integrated value of the signal strength of the return beam L2 detected at each scanning position of the entire scanning range, and determines whether or not the calculated integrated value is within a predetermined threshold value from a normal value grasped in advance, thereby determining whether or not the laser processing of the processing target 100 is normally performed.

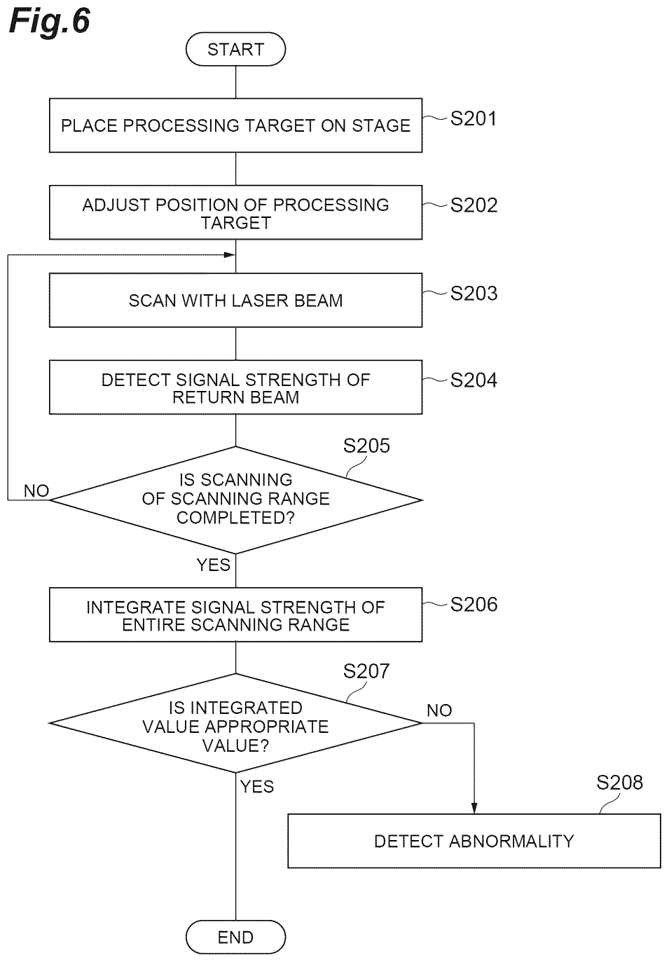

A second operation example of the laser processing apparatus 1A will be described with reference to FIG. 6. The processing of steps S201 to S204 is similar to that of steps S101 to S104. In the second operation example, the processing of steps S203 and S204 is executed until scanning within a predetermined scanning range is completed (step S205: NO). When the scanning within the scanning range (that is, irradiation of all scanning positions in the scanning range with the laser beam L1) is completed (step S205: YES), the control unit 9 acquires an integrated value of the signal strength of the return beam L2 detected at each scanning position of the entire scanning range (step S206).

In step S207, the control unit 9 determines whether or not the integrated value obtained in step S206 is an appropriate value. For example, the control unit 9 determines whether or not the integrated value is within the predetermined threshold value from the normal value grasped in advance. If the difference between the integrated value and the normal value exceeds the threshold value (step S207: NO), the control unit 9 detects an abnormality of the processing state of the processing target 100 (step S208). Then, the control unit 9 executes predetermined abnormal-time processing. For example, the control unit 9 may output display information indicating the occurrence of an error to a display unit such as a display included in the control unit 9, or may output an alert sound or the like indicating the occurrence of an error from a speaker or the like included in the control unit 9. On the other hand, when it is determined that the integrated value is the appropriate value (that is, the difference between the integrated value and the normal value is within the threshold value) (step S208: NO), the abnormal-time processing is not executed, and the laser processing on the processing target 100 by the laser processing apparatus 1A is normally completed.

In the laser processing apparatus 1A described above, by using the polarization beam splitter 6 and the quarter-wave plate 7, the detection efficiency of the return beam L2 from the processed surface 100a of the processing target 100 can be improved as compared with a case where the polarization beam splitter 6 and the quarter-wave plate 7 are not used. More specifically, all of the return beam L2 (linear polarization beam L22) can be reflected by the polarization beam splitter 6 and guided to the light detection unit 8A. Furthermore, by disposing the quarter-wave plate 7 between the polarization beam splitter 6 and the galvano scanner 5, the size of the quarter-wave plate 7 can be reduced as compared with a case where the quarter-wave plate 7 is disposed between the fθ lens 4 and the processing target 100 (stage 3). In other words, it is not necessary to increase the size of the quarter-wave plate 7 in accordance with the size of the processing target 100 so as to cover the entire processing target 100 (the processed surface 100a). As a result, the entire laser processing apparatus 1A can be downsized. In addition, by not disposing the quarter-wave plate 7 at a position facing the processing target 100, it is also possible to suppress contamination of the quarter-wave plate 7 due to splashes or the like generated from the processing target 100 at the time of laser processing.

As in the above embodiment, the control unit 9 may monitor the processing state of the processing target 100 on the basis of the return beam L2 (in the present embodiment, the signal strength of the return beam L2) detected by the light detection unit 8A. With the above configuration, the processing state of the processing target 100 can be easily monitored on the basis of the return beam L2 detected at the time of laser processing. More specifically, since the light detection unit 8A can detect the return beam L2 for monitoring the processing state at the same time as irradiating the processing target 100 with the laser beam L1, it is possible to easily monitor the processing state during the processing step.

As in the above embodiment, the light detection unit 8A may detect the signal strength of the return beam L2, and the control unit 9 may detect the abnormality of the processing state of the processing target 100 on the basis of the signal strength detected by the light detection unit 8A. With the above configuration, it is possible to appropriately detect the abnormality of the processing state on the basis of the signal strength of the return beam L2 and appropriately handle the abnormality.

As in the above-described embodiment (first operation example), the control unit 9 may correct the signal strength of the return beam L2 on the basis of the scanning position of the laser beam L1, and may detect the abnormality of the processing state of the processing target 100 on the basis of the signal strength after correction. With the above configuration, the signal strength is corrected on the basis of the tendency that the signal strength of the detected return beam L2 becomes smaller as the irradiation position (scanning position) of the laser beam L1 is farther from the center of the scanning range, whereby the magnitude of the signal strength of the return beam L2 detected at each position in the scanning range can be equalized. Thus, it is possible to determine whether or not laser processing is normally performed (that is, whether or not the signal strength (correction value) is an appropriate value) for each scanning position on the basis of a uniform reference.

As in the above embodiment (first operation example), every time the irradiation of the scanning position with the laser beam L1 is executed, the control unit 9 may determine whether or not the laser processing at the scanning position is normally performed on the basis of the signal strength detected at the scanning position, and may detect an abnormality of the processing state of the processing target 100 in response to the determination that the laser processing at the scanning position is not normally performed. With the above configuration, it is possible to appropriately and immediately detect the abnormality of the processing state during the processing step.

As in the above-described embodiment (first operation example), the control unit 9 may determine whether or not the signal strength (in the present embodiment, the corrected value) of the return beam L2 is an appropriate value on the basis of the relationship among the irradiation energy of the laser beam L1 output from the laser beam source 2, the signal strength of the return beam L2, and the diameter of the processing mark formed on the processed surface 100a, and the target value of the diameter of the processing mark, and may detect an abnormality of the processing state of the processing target 100 in response to a determination that the signal strength is not an appropriate value. With the above configuration, during the processing step, the abnormality of the processing state can be appropriately detected on the basis of the relationship between the irradiation energy of the laser beam L1, the signal strength of the return beam L2, and the diameter of the processing mark.

As in the above embodiment (second operation example), the control unit 9 may integrate the signal strength of the return beam L2 detected at each scanning position in the entire predetermined scanning range, and may detect the abnormality of the processing state of the processing target 100 on the basis of the integration result. With the above configuration, by using the integration result of the signal strength of the return beam L2 detected in the entire scanning range, the difference in the signal strength due to the difference in the scanning position can be absorbed, and the abnormality can be detected in units of the scanning range. In addition, since the signal strength of the return beam L2 detected at each scanning position does not need to be corrected, the amount of calculation (that is, the processing load of the control unit 9) can be reduced accordingly.

A laser processing method executed by the laser processing apparatus 1A is a method of processing the processing target 100 by focusing the laser beam L1 on the processed surface 100a of the processing target 100 placed (supported) on the stage 3 by the fθ lens 4. This laser processing method includes a step of guiding the laser beam L1 output from the laser beam source 2 to the galvano scanner 5 through the polarization beam splitter 6 and the quarter-wave plate 7 in this order, and scanning, in the galvano scanner 5, the processed surface 100a with the laser beam L1 by operating the galvano mirror 5a to change the incident angle of the laser beam L1 with respect to the fθ lens 4 (for example, step S103 in FIG. 5 and step S203 in FIG. 6, and the like), and a step of detecting, by the light detection unit 8A, the return beam L2 of the laser beam L1 from the processed surface 100a of the processing target 100 irradiated with the laser beam L1, the return beam L2 passing through the fθ lens 4, the galvano scanner 5, the quarter-wave plate 7, and the polarization beam splitter 6 in this order (for example, step S104 in FIG. 5 and step S204 in FIG. 6, and the like). According to the above laser processing method, effects similar to those of the laser processing apparatus 1A described above are obtained.

The laser processing method may further include a step of monitoring the processing state of the processing target 100 on the basis of the return beam L2 detected by the light detection unit 8A (for example, steps S105 to S107 in FIG. 5 and steps S206 to S208 in FIG. 6, and the like). With the above configuration, the processing state of the processing target 100 can be easily monitored on the basis of the return beam L2 detected at the time of laser processing.

In the laser processing method, the signal strength of the return beam L2 may be detected in the detecting step, and the abnormality of the processing state of the processing target 100 may be detected on the basis of the detected signal strength in the monitoring step. With the above configuration, it is possible to appropriately detect the abnormality of the processing state on the basis of the signal strength of the return beam L2 and appropriately handle the abnormality.

In the laser processing method, the monitoring step may include a step of correcting the signal strength on the basis of the scanning position of the laser beam L1 (for example, step S105 in FIG. 5) and a step of detecting an abnormality of the processing state of the processing target 100 on the basis of the signal strength after correction (for example, steps S106 and S107 in FIG. 5). With the above configuration, the magnitudes of the signal strength of the return beam L2 detected at respective positions in the scanning range are equalized, and whether or not the laser processing is normally performed can be determined for each scanning position on the basis of a uniform reference.

In the laser processing method, the monitoring step may include a step (for example, step S106 in FIG. 5) of determining whether or not the laser processing at the scanning position is normally performed on the basis of the signal strength detected at the scanning position every time the irradiation of the scanning position with the laser beam L1 is executed, and a step (for example, step S107 in FIG. 5) of detecting an abnormality of the processing state of the processing target 100 in response to the determination that the laser processing at the scanning position is not normally performed. With the above configuration, it is possible to appropriately and immediately detect the abnormality of the processing state during the processing step.

In the laser processing method, the monitoring step may include a step (for example, step S106 in FIG. 5) of determining whether or not the signal strength is an appropriate value on the basis of the relationship among the irradiation energy of the laser beam L1 output from the laser beam source 2, the signal strength of the return beam L2, and the diameter of the processing mark formed on the processed surface 100a, and the target value of the diameter of the processing mark, and a step (for example, steps S106 and S107 in FIG. 5) of detecting an abnormality of the processing state of the processing target 100 in response to the determination that the signal strength is not the appropriate value. With the above configuration, during the processing step, the abnormality of the processing state can be appropriately detected on the basis of the relationship among the irradiation energy of the laser beam L1, the signal strength of the return beam L2, and the diameter of the processing mark.

In the laser processing method, the monitoring step may include a step of integrating the signal strength of the return beam L2 detected at each scanning position in the entire predetermined scanning range (for example, step S206 in FIG. 6), and a step of detecting the abnormality of the processing state of the processing target 100 on the basis of the integration result (for example, steps S207 and S208 in FIG. 6). With the above configuration, by using the integration result of the signal strength detected in the entire scanning range, a difference in the signal strength due to a difference in the scanning position can be absorbed, and the abnormality can be detected in units of the scanning range. In addition, the signal strength of the return beam L2 detected at each scanning position does not need to be corrected, and thus the amount of calculation can be reduced accordingly.

### Second Embodiment

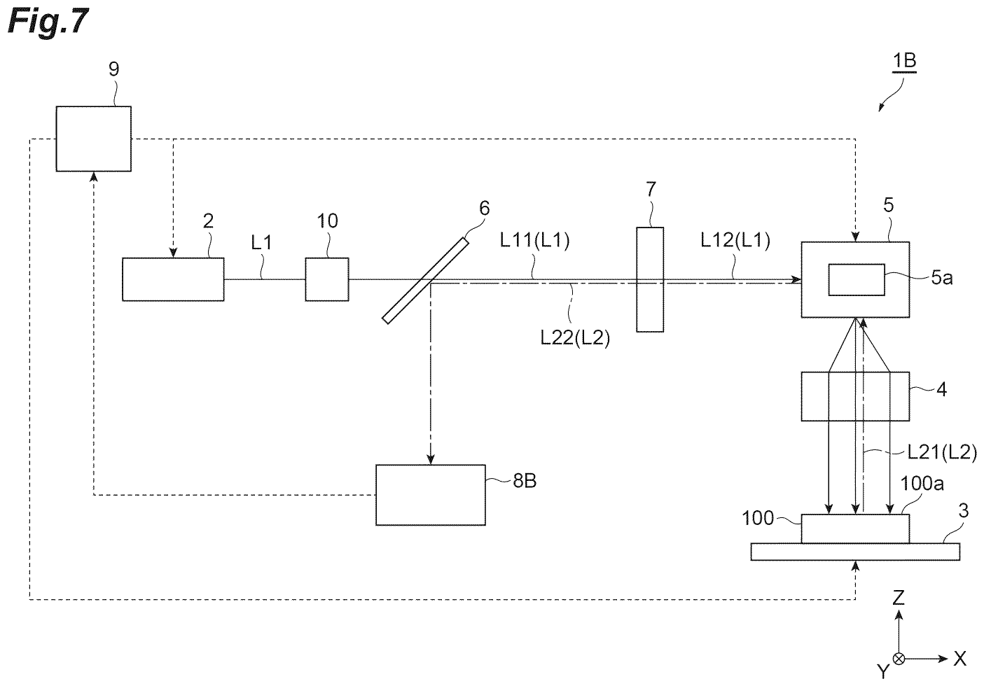

A laser processing apparatus 1B according to a second embodiment illustrated in FIG. 7 is different from the laser processing apparatus 1A in further including a beam shaping unit 10. Further, the laser processing apparatus 1B is also different from the laser processing apparatus 1A in including a light detection unit 8B instead of the light detection unit 8A.

The beam shaping unit 10 is a beam shaping element that performs beam shaping of the laser beam L1. The beam shaping unit 10 is, for example, a beam homogenizer. When such beam shaping by the beam shaping unit 10 is performed, the beam profile (beam shape) on the processed surface 100a changes according to the distance between the processing lens (fθ lens 4) and the processed surface 100a of the processing target 100 (that is, the distance between the fθ lens 4 and the stage 3). Therefore, in the second embodiment, in order to observe the beam profile during the laser processing, the light detection unit 8B is configured to be able to detect the two-dimensional image of the return beam L2. For example, the light detection unit 8B includes a camera.

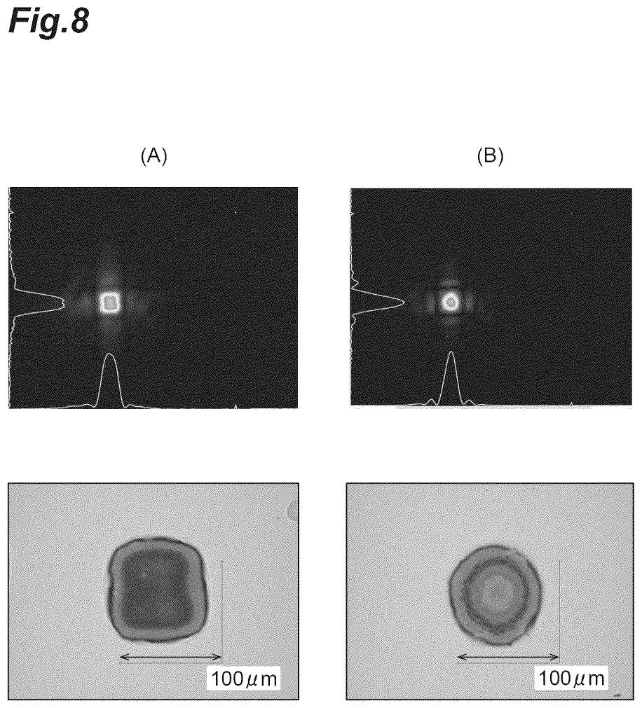

(A) and (B) of FIG. 8 illustrate examples of a two-dimensional image (upper side) of the return beam L2 detected (imaged) by the light detection unit 8B when the processed surface 100a is irradiated with the laser beam L1 and an observation image (lower side) of a processing mark actually formed on the processed surface 100a, respectively. (A) of FIG. 8 illustrates a two-dimensional image (upper side) and an observation image (lower side) when the distance between the fθ lens 4 and the processed surface 100a is appropriate and a processing mark having an appropriate shape close to a predetermined target shape is obtained. (B) of FIG. 8 illustrates a two-dimensional image (upper side) and an observation image (lower side) when the distance between the fθ lens 4 and the processed surface 100a is not appropriate and a processing mark having an inappropriate shape different from the target shape is obtained.

From the results illustrated in FIG. 8, it has been confirmed that there is a correlation between the two-dimensional image of the return beam L2 captured by the light detection unit 8B when the processed surface 100a is irradiated with the laser beam L1 and the shape of the processing mark formed on the processed surface 100a. That is, it has been confirmed that it is possible to estimate an approximate shape of the processing mark formed on the processed surface 100a from the two-dimensional image of the return beam L2. Therefore, by adjusting the distance between the fθ lens 4 and the processed surface 100a so as to obtain a two-dimensional image corresponding to the processing mark having an appropriate shape close to the target shape as illustrated in (A) of FIG. 8, laser processing can be appropriately performed. Therefore, the control unit 9 adjusts the distance between the fθ lens 4 and the processed surface 100a in such a manner that the two-dimensional image corresponding to the target shape is detected by the light detection unit 8B on the basis of, for example, the relationship between the two-dimensional image captured by the light detection unit 8B and the shape of the processing mark formed on the processed surface 100a, and the target shape of the processing mark. Here, as illustrated in FIG. 8, the relationship between the two-dimensional image and the shape of the processing mark is information in which the observation images of some processing marks are associated with the two-dimensional images corresponding to the observation images.

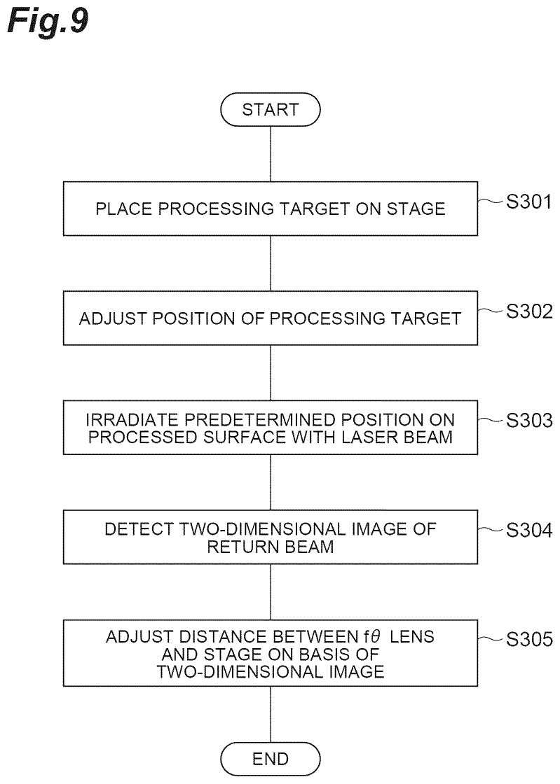

An operation example of the laser processing apparatus 1B will be described with reference to FIG. 9. Steps S301 and S302 are similar to steps S101 and S102.

In step S303, the laser processing apparatus 1B irradiates a predetermined position on the processed surface 100a with the laser beam L1.

In step S304, the light detection unit 8B detects a two-dimensional image of the return beam L2 of the laser beam L1 (see the upper side of (A) or (B) of FIG. 8).

In step S305, the control unit 9 adjusts the distance between the fθ lens 4 and the stage 3 (that is, the distance between the fθ lens 4 and the processed surface 100a) on the basis of the two-dimensional image detected by the light detection unit 8B. For example, the control unit 9 adjusts the distance between the fθ lens 4 and the stage 3 in such a manner that the two-dimensional image corresponding to the target shape is detected by the light detection unit 8B on the basis of the relationship between the two-dimensional image detected by the light detection unit 8B and the shape of the processing mark formed on the processed surface 100a, and the target shape of the processing mark. For example, the control unit 9 drives the stage 3 and adjusts the position (height position) of the stage 3 in the Z-axis direction to thereby adjust the distance between the fθ lens 4 and the stage 3.

For example, the laser processing apparatus 1B can grasp the appropriate distance between the fθ lens 4 suitable for the processing target 100 and the stage 3 by executing the processing illustrated in FIG. 9 using the adjustment sample (the processing target 100) prepared for first adjusting the distance between the fθ lens 4 and the stage 3. Thereafter, when laser processing is performed on the processing target 100 of the same type as the adjustment sample, the laser processing apparatus 1B (the control unit 9) sets the distance between the fθ lens 4 and the stage 3 to the appropriate distance and then starts laser processing on the processed surface 100a, whereby the laser processing accuracy of the processed surface 100a can be improved.

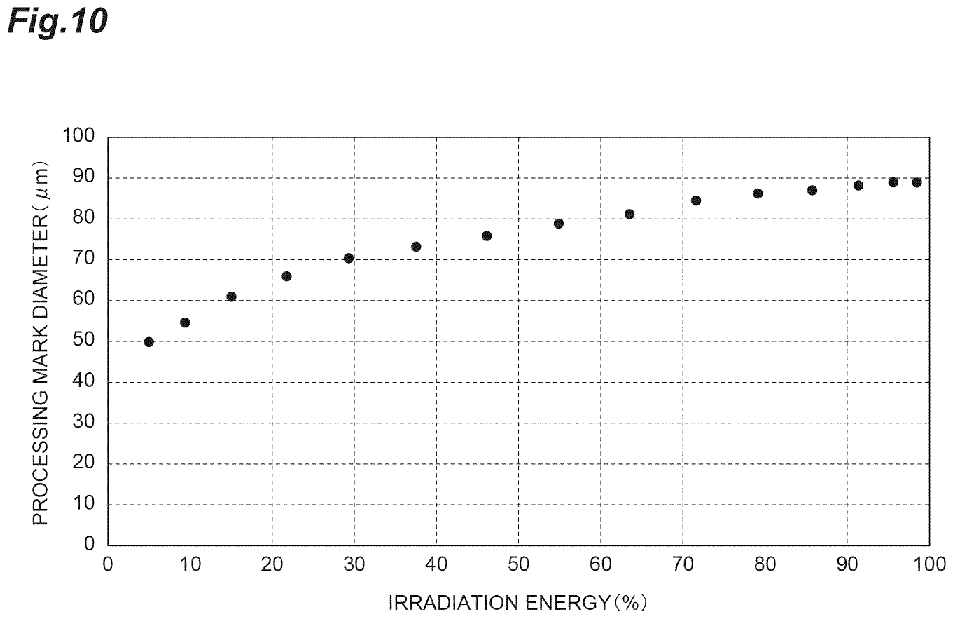

In addition, with the laser processing apparatus 1B, it is also possible to easily grasp the relationship between the irradiation energy (%) of the laser beam L1 and the diameter (μm) of the processing mark as illustrated in FIG. 10. For example, a case where the beam shaping unit 10 performs beam shaping so that the beam profile of the laser beam L1 follows a Gaussian distribution will be considered. In such a case, a circular two-dimensional image is obtained by the light detection unit 8B. Further, as described above, there is a correlation between the two-dimensional image obtained by the light detection unit 8B and the shape of the processing mark actually formed on the processed surface 100a. Therefore, it is possible to calculate (estimate) the diameter of the processing mark from the two-dimensional image by grasping the correlation between the two-dimensional image and the shape (diameter) of the processing mark in advance. For example, the control unit 9 can easily acquire the information as illustrated in FIG. 10 by executing processing of associating the irradiation energy of the laser beam L1 output from the laser beam source 2 with the two-dimensional image of the return beam L2 of the laser beam L1 and the diameter of the processing mark calculated from the correlation while changing the scanning position and the irradiation energy of the laser beam L1.

In the laser processing apparatus 1B, the light detection unit 8B detects the two-dimensional image of the return beam L2, and the control unit 9 adjusts the distance between the fθ lens 4 and the stage 3 (that is, the distance between the fθ lens 4 and the processed surface 100a) on the basis of the two-dimensional image detected by the light detection unit 8B. That is, in the laser processing method executed by the laser processing apparatus 1B, the two-dimensional image of the return beam L2 is detected in the detecting step (for example, step S304 in FIG. 9), and the distance between the fθ lens 4 and the stage 3 is adjusted on the basis of the detected two-dimensional image in the monitoring step (for example, step S305 in FIG. 9). With the above configuration, the distance between the fθ lens 4 and the stage 3 can be adjusted on the basis of the two-dimensional image (that is, the beam profile) of the return beam L2 from the processing target 100 so that the beam profile at the processing position (irradiation position) on the processed surface 100a has an appropriate shape. Thus, the processing quality can be improved.

In the above embodiment, the control unit 9 may adjust the distance between the fθ lens 4 and the stage 3 (that is, the distance between the fθ lens 4 and the processed surface 100a) so that the two-dimensional image corresponding to the target shape is detected by the light detection unit 8B on the basis of the relationship between the two-dimensional image and the shape (for example, a diameter or the like) of the processing mark formed on the processed surface 100a, and the target shape of the processing mark. That is, in the laser processing method executed by the laser processing apparatus 1B, in the monitoring step (for example, step S305 in FIG. 9), the distance between the fθ lens 4 and the stage 3 may be adjusted so that the two-dimensional image corresponding to the target shape is detected by the light detection unit 8B on the basis of the relationship between the two-dimensional image and the diameter of the processing mark formed on the processed surface 100a, and the target shape of the processing mark. With the above configuration, the distance between the fθ lens 4 and the stage 3 can be appropriately adjusted on the basis of the relationship between the two-dimensional image and the shape of the processing mark grasped in advance.

### Modification Example

Although one embodiment of the present disclosure has been described above, the present disclosure is not limited to the above embodiment. The material and shape of each configuration are not limited to the above-described material and shape, and various materials and shapes can be employed.

For example, in the above embodiment, although a configuration is provided in which the laser beam L1 is transmitted through the polarization beam splitter 6 and the return beam L2 is reflected by the polarization beam splitter 6, a configuration may be provided in which the laser beam L1 is reflected by the polarization beam splitter 6, and the return beam L2 is transmitted through the polarization beam splitter 6. More specifically, in the above embodiment, the first polarization component (the linear polarization beam L11) of the laser beam L1 transmitted through the polarization beam splitter 6 is guided to the processing target 100. However, a linear polarization beam having only the second polarization component of the laser beam L1 reflected by the polarization beam splitter 6 (a component traveling upward in FIG. 1) may be guided to the processing target 100 via the quarter-wave plate 7, the galvano scanner 5, and the fθ lens 4. In this case, the return beam L2 returning to the polarization beam splitter 6 following a path opposite to that of the linear polarization beam having only the second polarization component of the laser beam L1 is a linear polarization beam having only the first polarization component. Therefore, the return beam L2 is transmitted through the polarization beam splitter 6 to reach the light detection unit 8A.

In addition, in the first operation example of the first embodiment, whether or not the laser processing is normally performed is determined on the basis of whether or not the ratio of the signal strength of the return beam L2 to the irradiation energy of the laser beam L1 is a normal value. However, whether or not the laser processing is normally performed may be determined more simply on the basis of whether or not the signal strength of the return beam L2 is a predetermined normal value.

In addition, in the first operation example of the first embodiment, the correction processing of the signal strength of the return beam L2 may be omitted. For example, in a case where a normal value of the signal strength of the return beam L2 is acquired in advance for each scanning position, it is possible to determine whether or not the signal strength of the return beam L2 is an appropriate value (that is, whether or not the laser processing has been normally performed) by comparing the signal strength of the return beam L2 before correction with a normal value prepared for each scanning position. However, by performing the correction processing, it is possible to eliminate the need to prepare a normal value to be compared for each scanning position.

Further, in the above embodiment, the outer surface (as an example, the surface of the metal layer 102 on the side opposite to the silicon substrate 101 side) of the processing target 100 is the processed surface 100a, but the processed surface to be subjected to the laser processing is not limited to the outer surface of the processing target. For example, in the above embodiment, an interface (that is, a surface located inside the processing target) between the silicon substrate 101 and the metal layer 102 may be a processed surface. In this case, for example, in FIG. 2, the processing target 100 may be arranged so that the silicon substrate 101 is on the upper side (fθ lens 4 side) and the metal layer 102 is on the lower side (stage 3 side). Then, the laser processing may be performed on the interface (processed surface) by irradiating the silicon substrate 101 with the laser beam L1 having a wavelength transmitted through the silicon substrate 101 to focus the laser beam L1 on the surface of the metal layer 102 on the silicon substrate 101 side (that is, the interface between the silicon substrate 101 and the metal layer 102). In this case, the return beam L2 generated at the interface is transmitted through the silicon substrate 101 and travels toward the fθ lens 4.

Further, the support unit that supports the processing target 100 is not limited to the stage 3. For example, instead of the stage 3, an arm member or the like configured to hold (sandwich) the side surface of the processing target 100 may be used as the support unit.

In addition, a part of configurations in one embodiment or modification example described above can be arbitrarily applied to configurations in other embodiments or modification examples.

### REFERENCE SIGNS LIST

1A, 1B Laser processing apparatus
2 Laser beam source
3 Stage
4 fθ lens
5 Galvano scanner (optical scanning unit)
5a Galvano mirror (dielectric mirror)
6 Polarization beam splitter
7 Quarter-wave plate
8A, 8B Light detection unit
9 Control unit
100 Processing target
100a Processed surface
L1 Laser beam
L2 Return beam

1: A laser processing apparatus, comprising:
a laser beam source configured to output a laser beam;
a support unit configured to support a processing target;
an fθ lens configured to focus the laser beam on a processed surface of the processing target;
an optical scanning unit configured to scan the processed surface with the laser beam by operating a dielectric mirror to adjust an incident angle of the laser beam with respect to the fθ lens;
a polarization beam splitter disposed between the laser beam source and the optical scanning unit on an optical path of the laser beam;
a quarter-wave plate disposed between the polarization beam splitter and the optical scanning unit on the optical path; and
a light detection unit configured to detect a return beam of the laser beam from the processed surface of the processing target irradiated with the laser beam, the return beam passing through the fθ lens, the optical scanning unit, the quarter-wave plate, and the polarization beam splitter in this order.

2: The laser processing apparatus according to claim 1, further comprising:
a control unit configured to monitor a processing state of the processing target on a basis of the return beam detected by the light detection unit.

3: The laser processing apparatus according to claim 2, wherein
the light detection unit detects signal strength of the return beam, and
the control unit detects an abnormality of a processing state of the processing target on a basis of the signal strength detected by the light detection unit.

4: The laser processing apparatus according to claim 3, wherein
the control unit corrects the signal strength on a basis of a scanning position of the laser beam, and detects an abnormality of a processing state of the processing target on a basis of the signal strength after correction.

5: The laser processing apparatus according to claim 3, wherein
the control unit determines whether or not laser processing at a scanning position is normally performed on a basis of the signal strength detected at the scanning position every time the irradiation of the scanning position with the laser beam is executed, and detects an abnormality of a processing state of the processing target in response to a determination that the laser processing at the scanning position is not normally performed.

6: The laser processing apparatus according to claim 3, wherein
the control unit determines whether or not the signal strength is an appropriate value on a basis of a relationship among irradiation energy of the laser beam output from the laser beam source, the signal strength, and a diameter of a processing mark formed on the processed surface, and a target value of the diameter of the processing mark, and detects an abnormality of a processing state of the processing target in response to a determination that the signal strength is not an appropriate value.

7: The laser processing apparatus according to claim 3, wherein
the control unit integrates the signal strength detected at each scanning position in an entire predetermined scanning range, and detects an abnormality of a processing state of the processing target on a basis of an integration result.

8: The laser processing apparatus according to claim 2, wherein
the light detection unit detects a two-dimensional image of the return beam, and
the control unit adjusts a distance between the fθ lens and the processed surface on a basis of the two-dimensional image detected by the light detection unit.

9: The laser processing apparatus according to claim 8, wherein
the control unit adjusts a distance between the fθ lens and the processed surface in such a manner that the two-dimensional image corresponding to a target shape is detected by the light detection unit on a basis of a relationship between the two-dimensional image and a shape of a processing mark formed on the processed surface, and the target shape of the processing mark.

10: A laser processing method for processing a processing target by focusing a laser beam on a processed surface of the processing target supported by a support unit with an fθ lens, the laser processing method comprising:
a step of guiding the laser beam output from a laser beam source to an optical scanning unit through a polarization beam splitter and a quarter-wave plate in this order, and scanning, in the optical scanning unit, the processed surface with the laser beam by operating a dielectric mirror to change an incident angle of the laser beam with respect to the fθ lens; and
a step of detecting, by a light detection unit, a return beam of the laser beam from the processed surface of the processing target irradiated with the laser beam, the return beam passing through the fθ lens, the optical scanning unit, the quarter-wave plate, and the polarization beam splitter in this order.

11: The laser processing method according to claim 10, further comprising:
a step of monitoring a processing state of the processing target on a basis of the return beam detected by the light detection unit.

12: The laser processing method according to claim 11, wherein
in the step of detecting, signal strength of the return beam is detected, and
in the step of monitoring, an abnormality of a processing state of the processing target is detected on a basis of the detected signal strength.

13: The laser processing method according to claim 12, wherein
the step of monitoring includes
a process of correcting the signal strength on a basis of a scanning position of the laser beam, and
a process of detecting an abnormality of a processing state of the processing target on a basis of the signal strength after correction.

14: The laser processing method according to claim 12, wherein
the step of monitoring includes
a step of determining whether or not laser processing at a scanning position is normally performed on a basis of the signal strength detected at the scanning position every time the irradiation of the scanning position with the laser beam is executed, and
a step of detecting an abnormality of a processing state of the processing target in response to a determination that the laser processing at the scanning position is not normally performed.

15: The laser processing method according to claim 12, wherein
the step of monitoring includes
a step of determining whether or not the signal strength is an appropriate value on a basis of a relationship among irradiation energy of the laser beam output from the laser beam source, the signal strength, and a diameter of a processing mark formed on the processed surface, and a target value of the diameter of the processing mark, and
a step of detecting an abnormality of a processing state of the processing target in response to a determination that the signal strength is not an appropriate value.

16: The laser processing method according to claim 12, wherein
the step of monitoring includes
a step of integrating the signal strength detected at each scanning position in an entire predetermined scanning range, and
a step of detecting an abnormality of a processing state of the processing target on a basis of an integration result.

17: The laser processing method according to claim 11, wherein
in the step of detecting, a two-dimensional image of the return beam is detected, and
in the step of monitoring, a distance between the fθ lens and the processed surface is adjusted on a basis of the detected two-dimensional image.

18: The laser processing method according to claim 17, wherein
in the step of monitoring, a distance between the fθ lens and the processed surface is adjusted in such a manner that the two-dimensional image corresponding to a target shape is detected by the light detection unit on a basis of a relationship between the two-dimensional image and a shape of a processing mark formed on the processed surface, and a target shape of the processing mark.
